(19) United States
(12) Patent Application Publication
(10) Pub. No.: US 2007/0072624 A1
(43) Pub. Date: Mar. 29, 2007

(54) Mobile access network server

(75) Inventors: Jarko Niemenmaa, Espoo (FI); Sebastian Kraufvelin, Tenhola (FI); Ville Ruutu, Espoo (FI)

Correspondence Address: FOLEY & LARDNER LLP, P.O. BOX 80278, SAN DIEGO, CA, 92138-0278, US

(73) Assignee: Nokia Corporation

(21) Appl. No.: 11/507,831

(22) Filed: Aug. 21, 2006

(30) Foreign Application Priority Data
Aug. 19, 2005 (GB) GB 0517064.2

(51) Int. Cl. H04Q 7/20

(52) U.S. Cl. 455/456.1

(57) ABSTRACT

A mobile access network server for supporting location position services comprising: receiving means arranged to receive at least one location request message; and transmitting means arranged to transmit a first message to a location server based on the received location request message and to transmit a second message to at least one mobile device based on the received location request message. The location server is arranged to perform a location position service wherein the mobile access network server is an unlicensed mobile access network server. The first and second messages enable a data communications link to be established between the at least one mobile device and the location server.

### BACKGROUND OF THE INVENTION

1. Field of the Invention

The present invention relates to unlicensed mobile access networks, and more particularly to the provision of location services in such networks.

2. Description of the Related Art

“Unlicensed Mobile Access” (UMA) is a proposal to create a BSS (base station sub-system) look-alike access system architecture for “tunnelled GSM” over unlicensed-band radio interfaces, for example using Bluetooth and WiFi (802.11) wireless networks. It is proposed that UMA may be used, for example, for coverage extensions in indoor applications (such as home or office applications) to capture otherwise fixed line traffic for cellular operators. Therefore in the US, UMA is perceived as a cheaper way to provide missing coverage to domestic users at home than the infrastructure investment of a macro network base station.

There is a current European proposal to use UMA architectures in combination with a GSM (global system for mobile communication) RAN (radio access network), known as a GERAN. The unlicensed mobile access network (UMAN) is proposed to consist of UMA network controllers (UNCs), and access points (APs). The APs proposed conform to known wireless communications standards for example to a BlueTooth or WiFi standard.

A consortium of companies have drafted specifications for UMANs. At least some of these draft UMAN specifications include some discussion of location services (LCS).

The published document “UMA Architecture (Stage 2) R1.0.2” discusses LCS support. Specifically discussed is emergency service support for United States Federal Communications Code (FCC) E911 Phase 2 requirements. A number of ways in which the location of a terminal performing an emergency call may be obtained are discussed (chapter 9.17.2.1 of the referenced document). In one way the UNC may maintain a database of Access Point (AP) locations. The AP location is then provided via a known UMA radio resource protocol message (URR), for example via an URR REGISTER REQUEST/URR REGISTER UPDATE message or via some management interface. In another way the terminal may provide its current location (e.g. obtained via the assisted GPS A-GPS interface) in a URR REGISTER/UPDATE message. In another way the UNC can look up a location database based on a public internet protocol (IP) address and/or media access control (MAC) address of a terminal. Location services are discussed in chapter 9.18 of the published document “UMA Architecture (Stage 2) R1.0.2”. Cell information (of possibly available GSM coverage) may be used by the UNC to determine the location of a terminal. As another possibility, the AP identity is mentioned. Cell and AP information can be provided from the terminal to the UNC using URR-REGISTER and URR-REGISTER UPDATE messages. Likewise, the document “UMA Protocols (Stage 3) R1.0.2” discusses LCS support. URR REGISTER REQUEST and URR REGISTER UPDATE UPLINK messages are identified as including the following information elements (IE) useful for location purposes: AP radio identity; cell identity; Geographic Location; and AP location. AP radio identity IE is used for transmission of Bluetooth Device address (BD-ADDR) or WLAN MAC Address of AP. There is a field called “Type of Identity” which contains only a value “IEEE MAC-address format”. Other values are for future use. A cell identity IE identifies the cellular cell. A geographic location IE can be used to deliver, for example, an A-GPS location estimate from the terminal. An AP location IE is for indicating the location of a terminal or an AP to the network.

These techniques though are different to the ongoing location standardization work being carried out with respect to location estimation in wireless networks. The open mobile alliance (OMA) standardisation organisation is currently carrying out work on a location standard for communications devices called secure user plane location (SUPL). The intention of this program is to standardise the use of location services within the user plane. As is known in the art a communication system can be divided into planes of operation.

Typically two planes are described; a control plane which is used for sending control messages and signalling between nodes of the communication system and the user plane which is used for transmitting the actual communication data between users. One advantage in standardizing the location services within the user plane is that once a communications link is arranged between two nodes, then any location data transmitted between the location server and the device to be located is transparent to the transport network used to support the communications link, i.e. any intermediate nodes carrying the location data treat the data as being normal communications traffic and therefore any modifications to the network brought on by improvements to the location algorithms need only to be implemented within the end points of the communications link and not throughout the whole network.

The simplest architecture supported by the secure user plane location (SUPL) standards typically comprises: a secure user plane location enabled terminal (SET), of which its location is to be determined; a secure user plane location location platform (SUPL Location Platform, or SLP), capable of doing the location determination; and a SUPL agent, for providing the original location request.

However, there is currently no support for the operation of SUPL within unlicensed wireless networks. Also UMA location as described within the above cited documents does not support advanced location methods such as Assisted Global positioning satellite GPS (A-GPS), or Enhanced Observed Time Difference (E-OTD) methods.

Furthermore, current SUPL procedures require setting up a communications link which is optimised for a conventional cellular wireless network with a signalling channel such as a SMS (short message service) or WAP (Wireless Access Protocol). For example, a step in the initiation of a secure user plane location algorithm is the transmission of an initiation message to the SET. This message is sent using a SMS (short messaging service) or WAP (wireless access protocol) message. These protocols are not currently supported by UMA networks.

### SUMMARY OF THE INVENTION

It is an aim of the invention, and embodiments thereof, to provide an improvement to unlicensed mobile access systems which offers improved location services for such systems.

There is provided according to the present invention a mobile access network server for supporting location position services comprising: receiving means arranged to receive at least one location request message; and transmitting means arranged to transmit a first message to a location server based on the received location request message and to transmit a second message to at least one mobile device based on the received location request message, the location server arranged to perform a location position service wherein the mobile access network server is an unlicensed mobile access network server and the first and second messages enable a data communications link to be established between the at least one mobile device and the location server.

In embodiments of the invention described above location position services can be carried out with respect to unlicensed mobile access networks.

The second message may be an unlicensed radio resource secure user position location URR SUPL message.

The first message may be a secure user plane location message. In embodiments of the invention as described above secure user plane location services may be performed.

The secure user plane location message may be a secure user plane location START message.

The first message may be a secure user plane location message embedded within a resource location protocol (RLP) message.

The receiving means may be further arranged to receive a further message, the further message may be transmitted from the location server in response to the second message.

The further received message may be a secure user plane location RESPONSE message.

The second message may be further based on the received further message.

The receiving means may be arranged to receive a secure user plane location position location message from the at least one user terminal and forward the received secure user plane location position location message to the location server.

The location server may comprise a secure user plane location location platform server.

According to a second aspect of the present invention there is provided a method for supporting location position services within a mobile access network comprising the steps of: receiving at an unlicensed mobile access network server at least one location request message; transmitting from the unlicensed mobile access network server a first message to a location server based on the received location request message; further transmitting from the unlicensed mobile access network server a second message to at least one mobile device based on the received location request message; establishing a data communications link between the at least one mobile device and the location server based on the first and second messages; and transmitting over the data communications link data to enable the location server to determine the location at the at least one mobile device.

The second message may be an unlicensed radio resource secure user position location (URR SUPL) message.

The first message may be a secure user plane location message.

The secure user plane location message may be a secure user plane location START message.

The step of transmitting from the unlicensed mobile access network server a first message may comprise the steps of: producing a secure user plane location message; wrapping the secure user plane location message within a resource location protocol message; and transmitting the resource location protocol message to the location server.

The method may further comprise the step of transmitting from the location server to the mobile access network server a further message, the further message based on the first message.

The further message may be a secure user plane location RESPONSE message.

The step of transmitting the first message may comprise the steps of: producing the first message based on the further message received from the location server and the received location request message; and transmitting the first message to the at least one mobile device.

According to a third aspect of the present invention there is provided a system comprising: at least one mobile device; a mobile access network server; and a location server for performing a location position service wherein the mobile access network server comprises receiving means arranged to receive at least one location request message; and transmitting means arranged to transmit a first message to a location server based on the received location request message and a second message to the at least on mobile device based on the received location request message, wherein the first and second messages enable a data communication link to be established between the at least one mobile device and the location server and furthermore wherein the mobile access network server is an unlicensed mobile access network server.

According to a fourth aspect of the present invention there is provided a computer program product arranged to carry out the method for supporting location position services within a mobile access network comprising the steps of: receiving at an unlicensed mobile access network server at least one location request message; transmitting from the unlicensed mobile access network server a first message to a location server based on the received location request message; further transmitting from the unlicensed mobile access network server a second message to at least one mobile device based on the received location request message; establishing a data communications link between the at least one mobile device and the location server based on the first and second messages; and transmitting over the data communications link data to enable the location server to determine the location at the at least one mobile device.

### BRIEF DESCRIPTION OF THE FIGURES

The invention is described by way of example only with reference to the accompanying figures in which:

FIG. 1 shows a simplified view of a conventional unlicensed mobile access architecture in which the invention and embodiments thereof may be implemented;

FIG. 2 shows a flow diagram demonstrating the operation of a conventional secure user plane location algorithm;

FIG. 3 shows a flow diagram demonstrating the operation of a location request within a unlicensed mobile access network using a first embodiment of the invention; and

FIG. 4 shows a flow diagram demonstrating the operation of a location request within an unlicensed mobile access network using a further embodiment of the invention.

### DESCRIPTION OF THE PREFERRED EMBODIMENTS

The invention is described herein by way of example with reference to a number of embodiments. The invention is described in the context of an unlicensed mobile access system operating in conjunction with a licensed mobile access system, and specifically, in exemplary embodiments, a GERAN system.

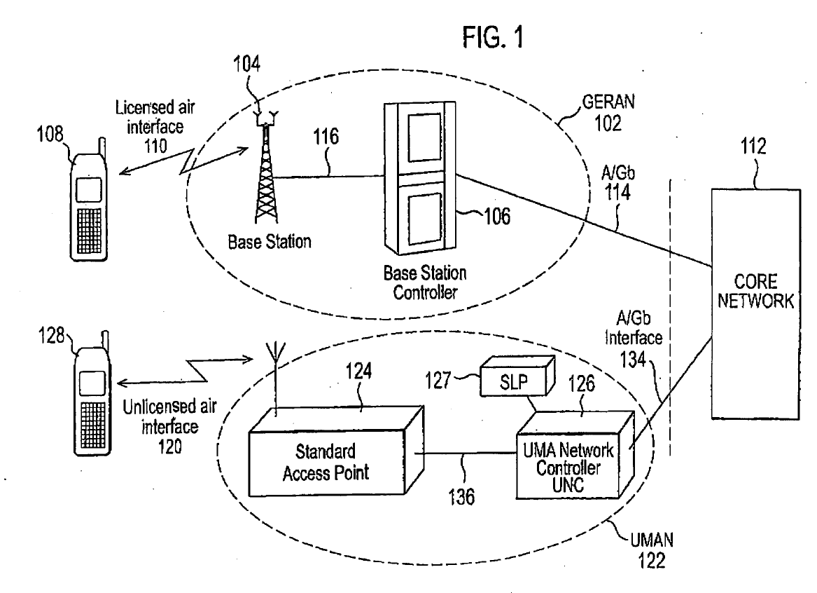

With reference to FIG. 1, there is shown a GERAN 102 including at least one base station 104 and at least one base station controller 106. A mobile terminal 108 is connected, via a licensed air interface 110, to the base station 104 of the GERAN 102. The base station 104 is connected to the base station controller 106 via a communication link 116. The base station controller 106 is connected to a core network 112 via an A/Gb interface connection 114. As is known in the art the A interface is the interface between the base station controller (BSC) and the second generation circuit switched network i.e. the mobile station controller (MSC). Similarly the Gb interface the interface between the base station subsystem (BSS) (the BSS typically comprising the combination of the BSC and the base transceiver station (BTS)) and the second generation packet switched core network i.e. the serving GPRS support node (SGSN).

With further reference to FIG. 1, there is shown a UMA Network (UMAN) 122 including at least one standard access point 124, or network access point, and at least one UMA network controller (UNC) 126, or network control element. A mobile terminal 128, being a UMA terminal, is connected, via an unlicensed air interface 120, to the standard access point 124 of the UMAN 122. The standard access point 124 is connected to the UNC 126 via a communication link 136. The UNC 126 is connected to the core network 112 via an A/Gb interface connection 134. An associated network element 127, associated with the UNC 126, such as a location server is illustrated in FIG. 1.

It should be noted that the mobile terminals 108 and 128 are preferably configured to connect in either a GERAN or a UMAN, in accordance with available network coverage and implementation requirements. Furthermore although the mobile terminals are represented in FIG. 1 as mobile telephone handsets, the mobile terminal may be any mobile device with the capability to connect to either a GERAN or a UMAN, examples of which include communication capable personal digital assistants, laptops with integral or removable communication capacity, or portable gaming devices with communication capability.

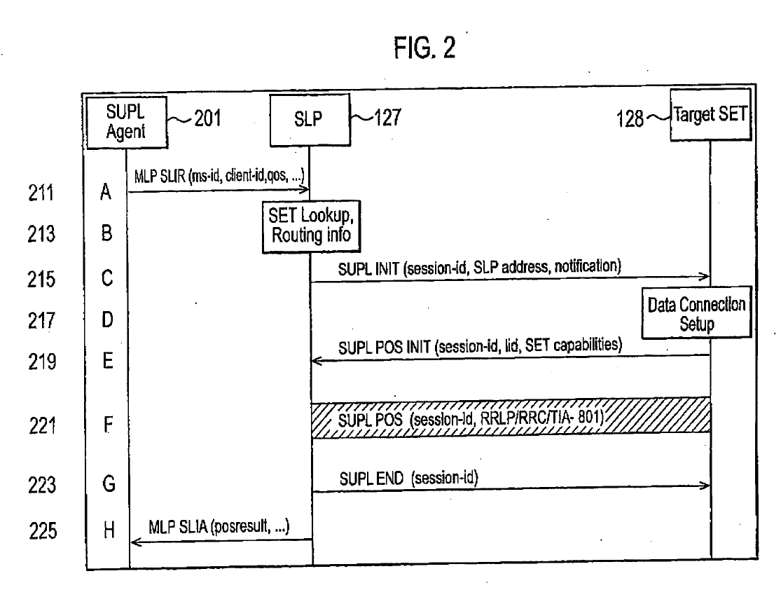

In order to assist the understanding of the embodiments of the invention it is helpful to describe a conventional secure user plane location (SUPL) message flow for a location request of a terminal (Target SET). With respect to FIG. 2 a simplified SUPL message flow for a network initiated request is shown. As described previously, at its simplest arrangement a SUPL architecture comprises, a SUPL agent 201—requesting the location information, a SUPL location Platform (SLP) 127—locating the target SET 128, and a target SET 128.

In a first step 211 the SUPL agent 201 passes a position request message to the SLP 127. This message is transmitted to the SLP 127 using a mobile location protocol standard location information request (MLP SLIP). The MLP is a standard defined by the open mobile alliance (OMA) in document LIF TS 101. The request message specifies such parameters as a mobile station identification value, a client identification value and a quality of service value, i.e quality of estimation service requirement value.

In the next step 213 the SLP 127, having received the MLP SLIR message, performs a series of tasks related to the values within the received message. The SLP therefore performs a SET lookup, and determines if any special routing information is required to contact the SET 128.

Once these tasks have been carried out, in the next step 215 the SLP 127 transmits a secure user plane location initialisation message (SUPL INIT) to the target SET 128. The SUPL INIT message contains the session ID identifying the current request, the SLP address and a notification value. The notification value is used by the SET 128 to determine what privacy and verification measures need to be carried out.

The target SET 128 having received the SUPL INIT message then in step 217 prepares a data connection between the SET 128 and the SLP 127.

The target SET 128, in step 219, transmits to the SLP 127 a secure user plane location initialisation position message (SUPL POS INIT). This SUPL POS INIT message contains information values such as the session ID value, a location ID value defining the cell information of the SET 128, and the location capabilities of the SET. The SET capabilities define the ability of the SET 128 to perform any of the enhanced or assisted positioning techniques such as assisted global positioning system (A-GPS) and enhanced observed time difference (E-OTD).

Once the SLP 127 has received the SUPL POS INIT message in step 219, the data connection between the SLP 127 and the target SET 128 which was set up in step 217 is used in step 221 to pass secure user plane location position (SUPL POS) messages.

The SUPL POS messages are those which are used to wrap the underlying position information content messages. For a GSM system the message is typically a Radio Resource Location service (LCS) Protocol message otherwise known as a RRLP message. The same type of message is also typically used in GPRS enabled systems. For other licensed radio networks other protocol messages are used. For example a radio resource control (RRC) message is typically used in so called third generation or 3G systems. In mobile communications systems using the code division multiple access 2000 (CDMA2000) system the message sent is that specified within Telecommunication Industry Association standards such as the TIA-801 standard. These location message protocols are well known in the field of control plane location service provision and are not further described here. Once the SLP 127 has arrived at a location determination using the SUPL POS data the SLP 127 in step 223 transmits a SUPL END message to the SET 128. The SUPL END message contains the session ID of the current interaction which allows the target SET 205 to disconnect the data connection between the SLP 203 and the target SET 205.

Following the step 223, the SLP 203 transmits a response message to the original request message to the SUPL Agent 201. It does this in a location protocol standard location information answer (MLP SLIA) message to the SUPL agent 201. This message contains the position result.

As has been described previously, the transmission of the SUPL INIT message in steps 215 is carried out over a WAP or SMS interface. This method can not be used with respect to a unlicensed radio access network (URAN) system as the URAN as not have as a defined capability a WAP or SMS capability.

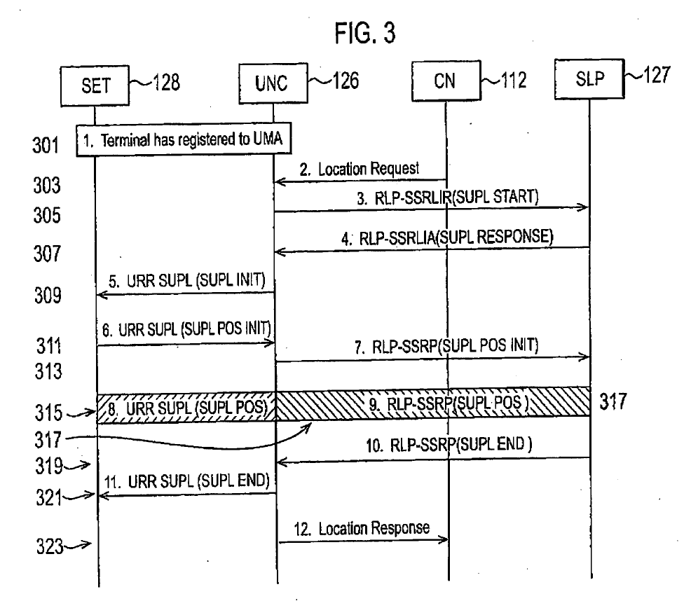

With respect to FIG. 3 an embodiment of the invention is shown in the implementation of an improved SUPL application over an unlicensed radio access network (URAN). Specifically FIG. 3 shows a position location request for a SET 128 originating from a party other than the SET 128. Network elements as previously described with respect to FIG. 1 are identified by the same reference numerals.

In order to more clearly understand the invention FIG. 3 shows a SUPL application with respect to a simplified network comprising the following network elements: the service equipped terminal (SET) 128; the Unlicensed mobile access (UMA) Network Controller (UNC) 126; the core network (CN) 112; and the SUPL location platform (SLP) 127. It would be understood that the same core processes would be equally applicable in more sophisticated network arrangements.

The first step 301 occurs prior to the position location process when the SET 128 registers itself at the UNC 126. This registration process is known in the art and is not described in any further detail.

The next step 303 occurs when the core network 112 forwards a position location request originating from a third party (not shown). This request is for a location estimate of the registered SET 128. This is shown in FIG. 3 by the location request arrow pointing from the CN 112 to the UNC 126. The location request is an A/Gb interface location request message. In other embodiments of the present invention the request is in the form of a message acceptable to the UNC identifying at least the SET and the client address.

The receipt of the request at the UNC 126 in this embodiment of the invention allows the UNC 126 to emulate some of the processes of a proxy SLP. As is known in the art with respect to the SUPL, when a SET roams outside of its home network, i.e. into a visited network, a location request may be answered provided that both the home network and the visiting network are equipped with SLP servers. In such a system the home network SLP performs the role of SLP position determination, but any communication with the SET located within the visiting network is carried out via the visiting network SLP. The home network SLP is usually described as the proxy SLP. In the embodiment of the present invention described hereafter the UNC 126 operating between the SLP 127 and the SET 128 the UNC 126 acts between the SLP 127 and SET 128 to set up an effective data communications link between the two endpoints.

Thus the UNC 126, in step 305, after receiving the location request transmits a resource location protocol standard SUPL roaming location immediate request (RLP SSRLIR) message to the SLP 127. Within the RLP SSRLIR message is wrapped a SUPL START message. The SUPL START message is typically an initial message sent from a SET 128 to a SLP 127. A SUPL START message typically comprises information regarding the SET capabilities, i.e. if the set is capable of GPS, Assisted GPS (A-GPS) or E-OTD estimation procedures, and also a value indicating the desired quality of position. If the SET 128 capability information is not available at the UNC 126 then no such information is sent. In some embodiments of the invention the SET 128 capability information is not transmitted as part of the SUPL START message.

The SLP 127 after receiving the RLP SSRLIR message containing the SUPL START message acknowledges receipt of the message in step 307 by transmitting a resource location protocol standard SUPL roaming location immediate answer (RLP SSRLIA) message to the UNC 126. Within the RLP SSRLIA message is wrapped a SUPL RESPONSE message. The SUPL RESPONSE message contains such information as the positioning method desired and the address of the SLP 127 used to set up the data connection to the SLP.

The UNC 126 on receiving the SUPL RESPONSE message then in step 309 transmits an unlicensed mobile access radio resource SUPL (URR SUPL) message to the SET 128. Within the URR SUPL message is wrapped a SUPL initialisation message (SUPL INIT). The SUPL INIT message comprises as discussed previously a session ID value, a network address to start a data communication, and if the SET capabilities have already been determined the chosen position estimation method. The network address defined in the SUPL INIT message is the UNC address 126. In further embodiments the SUPL INIT comprises the SLP 127 address.

The SET 128 on receiving the URR SUPL message processes this message and responds in step 311 by transmitting from the SET 128 a URR SUPL message to the UNC 126. Within the URR SUPL message transmitted to the UNC 126 is wrapped a SUPL position initialisation (SUPL POS INIT) message. The SUPL POS INIT message as previously described with reference to FIG. 2 comprises SET capability information and a session id value.

The UNC in the step 313 transmits to the SLP 127 a resource location protocol standard SUPL roaming position (RLP SSRP) message. Within the RLP SSRP message is embedded the SUPL POS INIT message received in the URR SUPL message from step 311.

After the RLP SSRP message has been received at the SLP, then using a first data communication link between the SET 128 and the UNC 126 as shown in step 315 and a second data communication link between the UNC 126 and the SLP 127 as shown in step 317 the data required to calculate the position estimation can be determined.

Thus in step 315, the data communication link between the SET 128 and the UNC 126 is established and URR SUPL messages transmitted between the endpoints. Within these messages are wrapped SUPL POS messages as described with reference to FIG. 2 in step 221.

In step 317, the data communication link between the UNC and the SLP 127 is established and RLP SSRP messages transmitted between the endpoints. Within these messages are wrapped SUPL POS messages.

The UNC 126 therefore performs the role of forwarding SUPL POS messages received from the SLP 127 in RLP SSRP messages to the SET 128 by wrapping the received SUPL POS messages into URR SUPL messages. Similarly the UNC forwards SUPL messages received from the SET 128 in URR SUPL to the SLP 127 by wrapping the received SUPL POS message into RLP SSRP messages.

Once an estimation result has been determined the SLP 127 transmits to the UNC 126 a RLP SSRP message (as shown in step 319 of FIG. 3). Within the RLP SSRP message is embedded a SUPL END message. The SUPL END message as described previously with respect to FIG. 2 step 223 comprises the session id value. Furthermore the SUPL END message comprises a position estimation result.

The UNC 126, in step 321, forwards the received SUPL END message to the SET 128 by wrapping the received SUPL END message-within a URR SUPL message.

The UNC 126 in step 323 then transmits a location response message to the CN 112. The location response message contains the position estimate as received by the UNC 126 in the SUPL END message received in step 319. The location response message in this embodiment is an A/Gb interface message. In other embodiments the location response message is transmitted to the CN 112 in a format the CN network element is capable of handling.

The above method therefore improves on the conventional UMA network location estimation techniques as it allows the application of advanced positional estimation methods not currently supported within URAN. This is enabled by the UNC 126 which controls the location request procedure following the receipt of a location receipt by enabling a first data communications link to be set up between the UNC 126 and the SLP 127 and a second communications link to be set up between the UNC 126 and the SET 128.

Furthermore the UNC enables standard SUPL messages and especially the SUPL INIT message to be passed to the SET in networks environments which do not have an available SMS or WAP system.

Also by enabling the creation of data links to pass the positional information used by the SLP 127 to produce a positional estimate, all of the advantages traditionally associated with SUPL systems when implemented within typical GSM/GPRS/3G/CDMA networks are available for so called unlicensed networks., For example the positional estimation algorithms can be updated by simply reformatting the data messages and therefore not requiring any modifications to the network elements themselves other than at the SET 128 and SLP 127 endpoints.

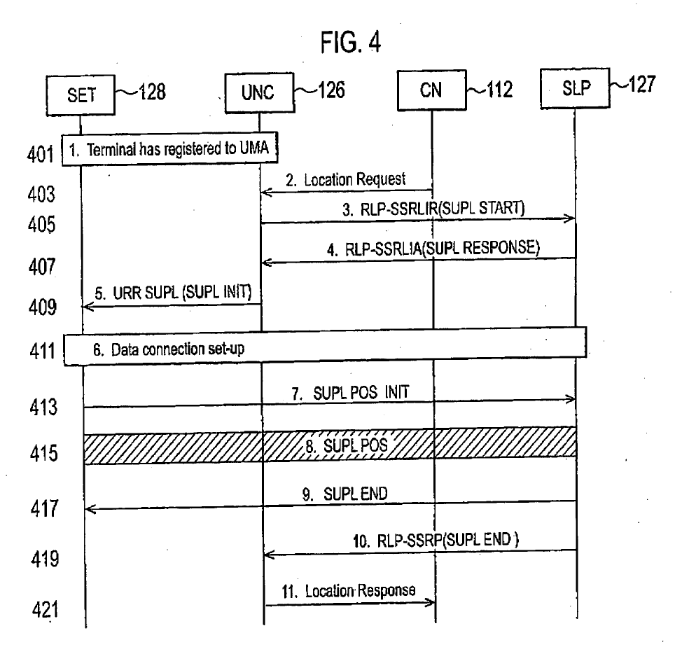

With reference to FIG. 4 a further embodiment of the present invention is shown. In this further embodiment the UNC 126 plays an active role in the position location estimation routine in the first and end steps, leaving the data communication to be sent between the SET and the SLP endpoints without any interference.

The first five steps of this further embodiment of the present invention are similar to the first five steps of the embodiment described above.

The first step 401 occurs prior to the position location process, when the SET 128 registers itself at the UNC 126. This registration process is known in the art and is not described in any further detail.

The next step 403 occurs when the core network 112 forwards a position location request originating from a third party (not shown). This request is for a location estimate of the registered SET 128. This is shown in FIG. 4 by the location request arrow pointing from the CN 112 to the UNC 126. The location request is an A/Gb interface message. In other embodiments of the present invention the request is in the form of a message acceptable to the UNC identifying at least the SET and the client address.

The UNC 126 in step 405, after receiving the location request, transmits a resource location protocol standard SUPL roaming location immediate request (RLP SSRLIR) message to the SLP 127. Within the RLP SSRLIR message is wrapped a SUPL START message. The SUPL START message is typically an initial message sent from a SET to a SLP. A SUPL START message typically comprises information regarding the SET capabilities, i.e. if the set is capable of GPS, Assisted GPS or E-OTD estimation procedures, and also a value indicating the desired quality of position. If the SET capability information is not available at the UNC then no such information is sent. In some embodiments of the invention the SET capability information is not transmitted as part of the SUPL START message.

The SLP 127 after receiving the RLP SSRLIR message containing the SUPL START message acknowledges receipt of the message in step 407 by transmitting a resource location protocol standard SUPL roaming location immediate answer (RLP SSRLIA) message to the UNC 126. Within the RLP SSRLIA message is wrapped a SUPL RESPONSE message. The SUPL RESPONSE message contains such information as the positioning method desired and the address of the SLP 127 used to set up the data connection to the SLP 127.

The UNC 126 on receiving the SUPL RESPONSE message then in step 409 transmits an unlicensed mobile access radio resource SUPL (URR SUPL) message to the SET 128. Within the URR SUPL message is wrapped a SUPL initialisation message (SUPL INIT). The SUPL INIT message comprises as discussed previously a session ID value, a network address of the SLP, and if the SET capabilities have already been determined the chosen position estimation method. The network address defined in the SUPL INIT message is the SLP 127 address as provided by the SUPL RESPONSE message received in step 407.

In the next step 411 the SET 128 and the SLP 127 set up a data communication link over the available network.

In the next step 413 the SET 128 transmits a SUPL position initialisation message (SUPL POS INIT) to the SLP 127. As described previously the SUPL POS INIT message provides the SLP 127 with information as to the SET capabilities.

Using the data communications link set up in step 411 the SET 128 and SLP 127, in step 415, exchange a series of SUPL POS messages in order to enable a position estimation to be arrived at by the SLP 127.

When the SLP 127 has determined an estimated position location for the SET 128, the SLP 127 transmits in step 417 a SUPL end message directly to the SET 128.

In the following step 419 the SLP 127 transmits to the UNC 126 a resource location protocol standard SUPL roaming position (RLP SSRP) message. Within the RLP SSRP message is wrapped a SUPL END message. This SUPL END message contains the location result.

In the following step 421 the UNC 126 passes the location response to the CN 112.

In this embodiment the UNC 126 again controls the location request procedure in setting up an effective data connection between the SET 128 and the SLP 127. The UNC furthermore improves on the previous embodiment in controlling the setting up of a single data communication link.

The further advantage this second embodiment therefore has over the previous embodiment is that the position request can be carried out even if the SET wanders out of the unlicensed network access area. As the communications link is one between the SET 128 and the SLP 127 then any handover from the unlicensed network to a licensed network should effectively be transparent.

It would be understood by the person skilled in the art that such systems could be controlled by the operation of hardware, software or any combination of hardware and software.

In further embodiments of the present invention the UNC 126 is arranged to transmit at least some of the SUPL messages transmitted to the SLP 127 without wrapping them within RLP messages.

In these embodiments the UNC 126 from the viewpoint of the SLP 127 looks to be effectively the SET. For example taking the first embodiment as shown in FIG. 3 as an example the steps 303, 305, 311, 317 and 319 ie the transmission and reception of the SUPL messages START, RESPONSE, POS INIT, POS and END are transmitted as SUPL messages in their unwrapped form.

This further embodiment has the further advantage over the previous embodiments in that there is no processing overhead associated with the wrapping and unwrapping of the SUPL messages.

In further embodiments, the method is capable of handling requests generated from the SET 128 itself. In such further embodiments a network element (not shown) within the CN 112 receives a location request from the SET, which is then forwarded to the UNC in a manner shown in any of the previous embodiments described above.

In other embodiments of the present invention the location request is received at the UNC 126 from the SET 128. The UNC 126 in response to the received location request in these embodiments transmits the SUPL START message (either wrapped as a RLP message or as itself) to the SLP 127 as described in any of the previous embodiments.

It should be noted that whilst the invention as described herein suggests implementation of an unlicensed mobile access network using BlueTooth or IEEE 802.xx technologies, the invention is not limited to such and may encompass any access technology. Similarly the invention is not limited to use with any licensed access technology such as GSM, GPRS, 3G, or CDMA 2000.

In some embodiments of the present invention Unlicensed Radio Resource messages transmitted between the UNC 126 and the SET 128 comprise an indicator that the sender of the URR message is capable of operating a SUPL location request procedure. These indicators are also known as classmarks. In some embodiments of the present invention these indicators or classmarks are transmitted within URR REGISTER REQUEST and/or URR REGISTER UPDATE messages.

Various modifications to the described embodiments will be understood by one skilled in the art. The scope of protection afforded by the invention is defined by the appended claims.

1. A mobile access network server for supporting location position services comprising:
receiving means arranged to receive at least one location request message; and
transmitting means arranged to transmit a first message to a location server based on the received location request message and to transmit a second message to at least one mobile device based on the received location request message, the location server arranged to perform a location position service wherein the mobile access network server is an unlicensed mobile access network server and the first and second messages enable a data communications link to be established between the at least one mobile device and the location server.

2. A mobile access network server-as claimed in claim 1, wherein the second message is an unlicensed radio resource secure user position location URR SUPL message.

3. A mobile access network server as claimed in claim 1 wherein the first message is a secure user plane location message.

4. A mobile access network server as claimed in claim 3, wherein the secure user plane location message is a secure user plane location START message.

5. A mobile access network server as claimed in claim 1, wherein the first message is a secure user plane location message embedded within a resource location protocol (RLP) message.

6. A mobile access network server as claimed in claim 1, wherein the receiving means are further arranged to receive a further message, the further message being transmitted from the location server in response to the second message.

7. A mobile access network server as claimed in claim 6, wherein the further received message is a secure user plane location RESPONSE message.

8. A mobile access network server as claimed in claim 6, wherein the second message is further based on the received further message.

9. A mobile access network server as claimed in claim 1 wherein the receiving means are arranged to receive a secure user plane location position location message from the at least one user terminal and forward the received secure user plane location position location message to the location server.

10. A mobile access network server as claimed in claim 1, wherein the location server comprises a secure user plane location platform server.

11. A method for supporting location position services within a mobile access network comprising the steps of:
receiving at an unlicensed mobile access network server at least one location request message;
transmitting from the unlicensed mobile access network server a first message to a location server based on the received location request message;
further transmitting from the unlicensed mobile access network server a second message to at least one mobile device based on the received location request message;
establishing a data communications link between the at least one mobile device and the location server based on the first and second messages; and
transmitting over the data communications link data to enable the location server to determine the location at the at least one mobile device.

12. A method as claimed in claim 11, wherein the second message is an unlicensed radio resource secure user position location (URR SUPL) message.

13. A method as claimed in claim 11, wherein the first message is a secure user plane location message.

14. A method as claimed in claim 13, wherein the secure user plane location message is a secure user plane location START message.

15. A method as claimed in claim 11 , wherein the step of transmitting from the unlicensed mobile access network server a first message comprises the steps of:
producing a secure user plane location message;
wrapping the secure user plane location message within a resource location protocol message; and
transmitting the resource location protocol message to the location server.

16. The method as claimed in claim 11, further comprising the step of transmitting from the location server to the mobile access network server a further message, the further message based on the first message.

17. A method as claimed in claim 16, wherein the further message is a secure user plane location RESPONSE message.

18. A method as claimed in claim 16, wherein the step of transmitting the first message comprising the steps of:
producing the first message based on the further message received from the location server and the received location request message; and
transmitting the first message to the at least one mobile device.

19. A system comprising:
at least one mobile device;
a mobile access network server; and
a location server for performing a location position service wherein the mobile access network server comprises receiving means arranged to receive at least one location request message;
and transmitting means arranged to transmit a first message to a location server based on the received location request message and a second message to the at least on mobile device based on the received location request message,
wherein the first and second messages enable a data communication link to be established between the at least one mobile device and the location server and furthermore wherein the mobile access network server is an unlicensed mobile access network server.

20. A computer program product comprising computer code embedded in a computer readable medium, the computer program product arranged to carry out the method for supporting location position services within a mobile access network comprising the steps of:
receiving at an unlicensed mobile access network server at least one location request message;
transmitting from the unlicensed mobile access network server a first message to a location server based on the received location request message;
further transmitting from the unlicensed mobile access network server a second message to at least one mobile device based on the received location request message;
establishing a data communications link between the at least one mobile device and the location server based on the first and second messages; and
transmitting over the data communications link data to enable the location server to determine the location at the at least one mobile device.
